(19) United States
(12) Patent Application Publication
(10) Pub. No.: US 2016/0313462 A1
(43) Pub. Date: Oct. 27, 2016

(54) SEISMIC DETECTION ELEMENT FOR A MICROMECHANICAL SENSOR

(71) Applicant: Robert Bosch GmbH, Stuttgart (DE)

(72) Inventors: Guenther-Nino-Carlo Ullrich, Reutlingen (DE); Benny Pekka Herzogenrath, Stuttgart (DE)

(21) Appl. No.: 15/133,893

(22) Filed: Apr. 20, 2016

(30) Foreign Application Priority Data
Apr. 27, 2015 (DE) 102015207639.3

(51) Int. Cl. G01V 1/16

(52) U.S. Cl. CPC G01V 1/162

(57) ABSTRACT

A seismic detection element for a micromechanical sensor, having a first functional layer, a second functional layer and a third functional layer, the second functional layer being situated between the first functional layer and the third functional layer; a defined number of cavities being developed in the second functional layer; reinforcement elements being situated between the cavities, which are firmly connected to the first functional layer and to the third functional layer.

### CROSS REFERENCE

The present application claims the benefit under 35 U.S.C. §119 of German Patent No. DE 102015207639.3 filed on Apr. 27, 2015, which is expressly incorporated herein by reference in its entirety.

### FIELD

The present invention relates to a seismic detection element for a micromechanical sensor. The present invention furthermore relates to a method for manufacturing a seismic detection element for a micromechanical sensor.

### BACKGROUND INFORMATION

Conventional sensors for measuring physical acceleration normally have a micromechanical structure made of silicon (sensor core) and an evaluation electronics. Sensor cores that make it possible to measure an acceleration orthogonally with respect to a main plane of the sensor core are known as Z sensors. Such sensors are used in the area of motor vehicles for example in ESP systems or in the area of mobile telephone communication.

European Patent No. EP 0 244 581 A1 describes a micromechanical sensor for the purpose of an automatic triggering of occupant protection devices.

European Patent No. EP 0 773 443 B1 describes a micromechanical acceleration sensor.

German Patent Application Nos. DE 10 2007 060 878 A1 and DE 10 2009 000 167 A1 describe micromechanical systems, which are structured not only from one individual compact layer, but in two different silicon layers. This makes it possible to form movable “vat-like” structures.

### SUMMARY

It is an objective of the present invention to provide an improved seismic detection element for a micromechanical sensor.

According to a first aspect, the objective may be achieved by, for example, a seismic detection element for a micromechanical sensor, having:
a first functional layer, a second functional layer and a third functional layer, the second functional layer being situated between the first functional layer and the third functional layer;
a defined number of cavities being developed in the second functional layer;
reinforcement elements being situated between the cavities, which are firmly connected to the first functional layer and to the third functional layer.

In this manner, it is possible to achieve a good robustness for the seismic detection element. Because of the cavities of the intermediary second functional layer, it is furthermore advantageously possible to structure the first functional layer and the third functional layer independently of each other.

According to a second aspect, the objective may be attained by, for example, method for manufacturing a seismic detection element for a micromechanical sensor, having the steps:
forming a third functional layer;
forming in sections a second functional layer on the third functional layer; and
forming a first functional layer on the third functional layer and the second functional layer.

One advantageous development of the seismic detection element is characterized in that the first functional layer has a first perforation and the third functional layer has a second perforation. This makes it possible to implement technical specifications for the seismic detection element.

Further advantageous developments of the seismic detection element are characterized in that diameters of the second perforation are definably smaller than diameters of the first perforation, or that diameters of the second perforation are essentially equal to diameters of the first perforation. This may advantageously support a variety of design options for the seismic detection element.

Another advantageous development of the seismic detection element is characterized in that the seismic detection element is designed as an asymmetrically developed rocker device of a Z sensor. An advantageous technical application for the seismic detection element is thereby provided.

Another advantageous development of the seismic detection element provides for the asymmetry of the rocker device to be designed as a geometric asymmetry and/or as a mass asymmetry of the rocker device. This makes it possible to provide favorable sensing properties for a Z sensor.

Another advantageous development of the seismic detection element is characterized in that the cavities are developed in at least one of the rocker arms of the rocker device. This likewise supports a great variety of designs for a micromechanical Z sensor.

Another advantageous development of the seismic detection element provides for the reinforcement elements to be connected at least in pointwise fashion to the first and third functional layer. This also advantageously increases a design variety for the seismic detection element.

The present invention is described in detail below with additional features and advantages with reference to the figures. Identical or functionally equivalent elements bear the same reference symbols. The figures are not necessarily drawn to scale.

### BRIEF DESCRIPTION OF THE DRAWINGS

FIG. 1 shows a conventional seismic detection element for a micromechanical Z sensor in a cross-sectional view.

FIG. 2 shows another known seismic detection element for a micromechanical Z sensor in a cross-sectional view.

FIG. 3 shows a cross-sectional view of the seismic detection element from FIG. 2 in a higher degree of detail.

FIG. 4 shows a cross-sectional view of a known seismic mass element of a micromechanical Z sensor.

FIG. 5 shows a cross-sectional view of a specific embodiment of a seismic mass element according to the present invention for a micromechanical Z sensor.

FIG. 6 shows a flow chart of the principle of a specific embodiment of a method for manufacturing a seismic mass element for a micromechanical sensor.

### DETAILED DESCRIPTION OF EXAMPLE EMBODIMENTS

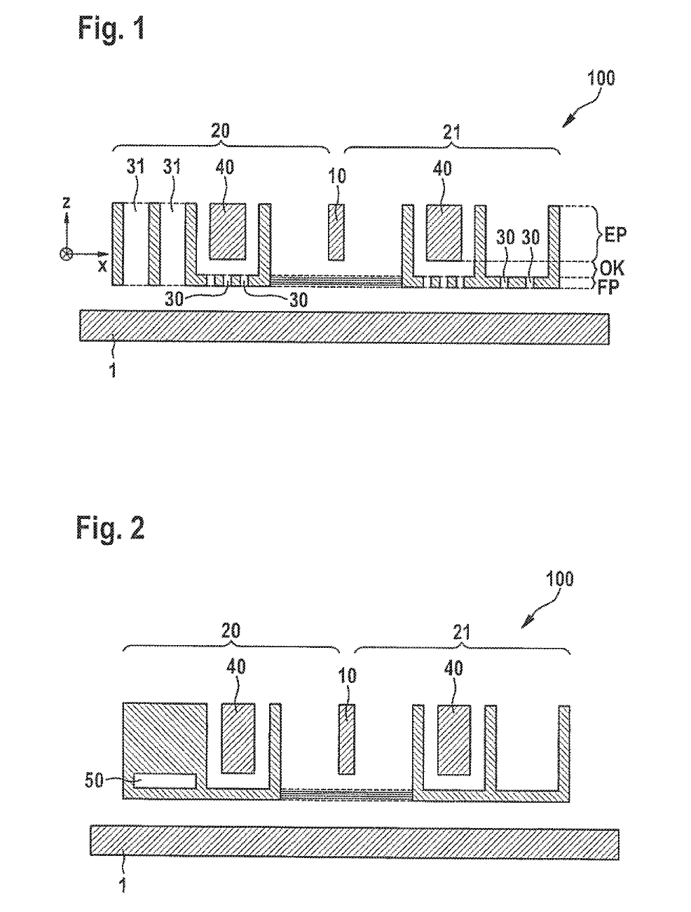

FIG. 1 shows in a simplified manner in a cross-sectional view a conventional seismic detection element 100 in the form of a rocker device for a micromechanical Z acceleration sensor.

The figure shows that the overall structure of the rocker device is implemented in three functional layers, namely, an upper first functional layer EP, a second functional layer OK situated between first functional layer EP and a third functional layer FP, and the lower third functional layer FP. Second functional layer OK may also be omitted if necessary. The two rocker arms 20, 21 have a second perforation 30, which may be developed preferably in the third functional layer FP. In first functional layer EP of first rocker arm 20, a first perforation 31 is developed, whose holes are definably larger than holes of the second perforation 30.

The second perforations 30 of the two rocker arms 20, 21 may be generally of equal size or may be of different size.

A size of the through holes of second perforation 30 is preferably in a range of approx. 0.5 μm to approx. 2 μm. A size of the through holes of first perforation 31 is preferably in a range of approx. 2 μm to approx. 3 μm. The differences of the mentioned perforations 30, 31 are subject to the process and may be changed only to a limited degree. They primarily derive from being able to etch away levels underneath using an etching gas in the manufacturing process. By way of a torsion spring 10, which is developed at a defined stiffness, the structure of rocker device 100 is supported or suspended on a silicon substrate 1 in a rotating or twistable fashion.

It can be seen that rocker arms 20, 21 are developed asymmetrically with respect to torsion spring 10 due to uneven mass distribution. The asymmetry may be achieved in the case of rocker arms 20, 21 of generally equal length (geometric symmetry) by an asymmetrical mass distribution of rocker arms 20, 21, for example resulting from the above-mentioned differing perforations 30, 31 of rocker arms 20, 21 and from different thicknesses of the two rocker arms 20, 21. Additionally or alternatively, however, the asymmetry may also be achieved by way of an asymmetrical geometry (e.g., differing arm lengths) of the two rocker arms 20, 21.

As a result of an acceleration acting orthogonally with respect to a main plane of the rocker device (vertical acceleration in the z direction), the structure of the rocker device is able to twist around the torsion spring 10 due to the asymmetry of the two rocker arms 20, 21. The rocker device is held at a defined electrical potential by an electronic circuit (not shown), fixed second electrodes (not shown) situated below the rocker device, which are used for measuring purposes, being held at other defined electrical potentials. The figure shows the “vat-shaped” structures of rocker arms 20, 21, fixed electrodes 40 being situated above the vat-shaped structures.

A change in inclination of the rocker device is detected with the aid of an electronic evaluation circuit (for example an ASIC, not shown) by detecting and evaluating charge changes on electrodes 40. In this manner, it is possible to ascertain a vertical acceleration (“in z direction”) acting on micromechanical Z sensor 100.

FIG. 2 shows that there may be a provision for seismic detection element 100 to develop a cavity 50 in first rocker arm 20. Cavity 50 may be developed in the rocker arm 20, 21, in which first functional layer EP is present with sufficient mass (“mass side of the rocker device”).

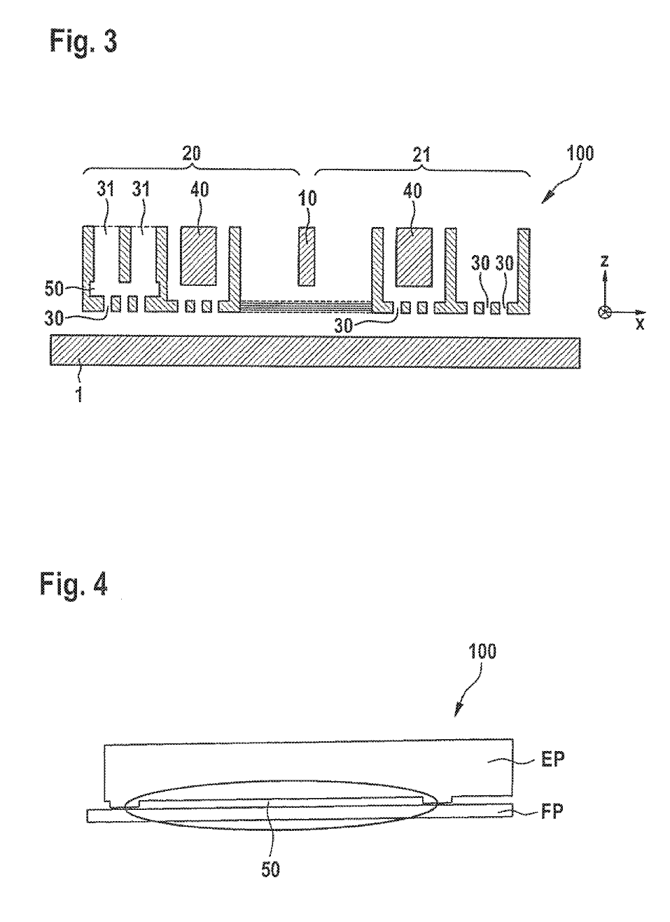

FIG. 3 shows in a higher degree of detail a cross-sectional view of seismic detection element 100 from FIG. 2. Due to the connection, established by way of cavity 50, between second perforation 30 in third functional layer FP and first perforation 31 in first functional layer EP of first rocker arm 20, it is possible to achieve a defined damping behavior of the two rocker arms 20, 21.

In one variant, cavity 50 may additionally also be situated in second rocker arm 21 (not shown). Preferably, cavity 50 may be developed wherever first functional layer EP is present with a sufficient mass. In another variant, it is also possible for multiple cavities 50 to be respectively developed in the two rocker arms 20, 21 (not shown).

Preferably, a number or the positioning of the mentioned perforations 30, 31 and of cavities 50 is adapted to a geometry and/or to a design of rocker device 100. All numbers, dimensions and arrangements of the mentioned elements in the figures are therefore to be regarded merely as exemplary and qualitative.

In first rocker arm 20 and/or in second rocker arm 21, cavity 50 may be developed to occupy a large space and a large area. With the aid of the second functional layer OK, third functional layer FP may be attached on the edge of first functional layer EP. In this manner, within the surrounding edge, third functional layer FP is self-supporting and may be structured in a manner decoupled from a structuring of first functional layer EP.

This creates a hollow space or a cavity 50 above third functional layer FP in all regions of the mass in which there exists no second functional layer OK. Prior to the gas-phase etching, this hollow space is filled with oxide material and thus stops the trenching process of first functional layer EP so that third functional layer FP may be structured independently of the trenching of first functional layer EP with the aid of a structuring level (not shown). In this manner, it is possible to achieve the relatively small holes of second perforation 30 of third functional layer FP by way of the structuring level.

FIG. 4 shows a cross-sectional view through the known rocker device of FIGS. 2 and 3. An oval marking indicates that cavity 50 has the result that third functional layer FP is developed in a very large area and quasi “self-supporting” and suspended below first functional layer EP. The spacious cavity 50 may result in a loss of mass of the rocker device in an order of magnitude of approx. five percent, which may impair a mass asymmetry of the two rocker arms 20, 21 and thus deteriorate a sensitivity of rocker device 100.

In order to increase a stability of the mentioned self-supporting areas, an implementation of reinforcement elements 60 is provided. In this manner, the stability of third functional layer FP may be increased advantageously.

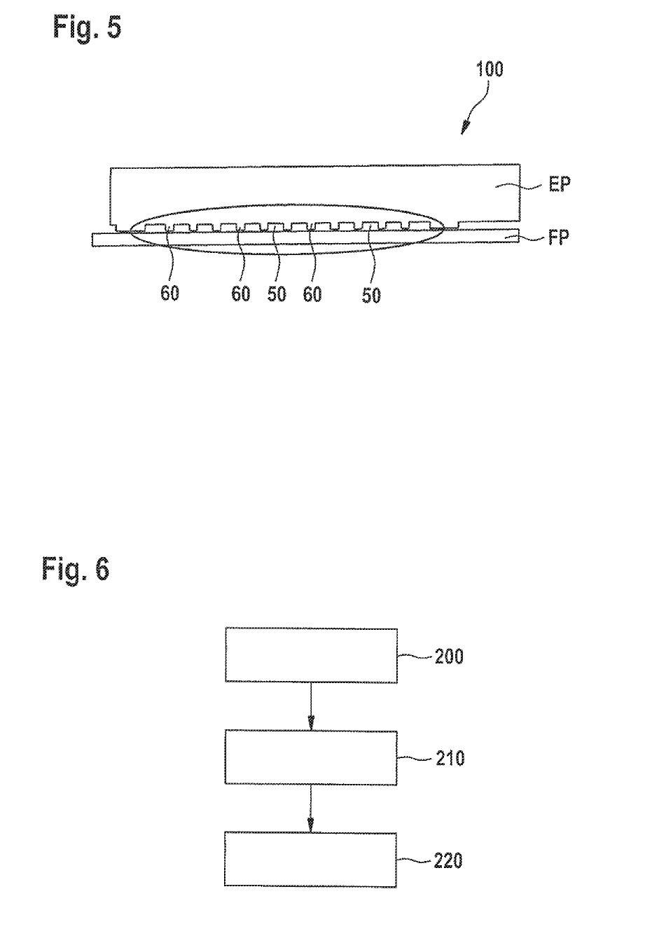

For this purpose, it is provided, as shown in the cross-sectional view of FIG. 5, to subdivide cavity 50 in the region of first rocker arm 20 of rocker device 100 at least in sections by reinforcement elements 60 so that as a result multiple cavities 50 having fixed connections in the form of reinforcement elements 60 are realized between third functional layer FP and first functional layer EP. This may be achieved for example in that third functional layer FP is locally attached in solid fashion to the mass of first functional layer EP.

For this purpose, it may be provided that an oxide (not shown) situated between first functional layer EP and third functional layer FP is removed only partially in the course of processing, cavity 50 being only partially filled with EP polysilicon so that crosspiece-like reinforcement elements 60 are formed between first functional layer EP and third functional layer FP. As a result, multiple smaller cavities 50 are formed between first functional layer EP and third functional layer FP.

Advantageously, this has the consequence that a mechanical stability or robustness of third functional layer FP and thus of the entire seismic detection element 100 is increased because third functional layer FP is reinforced by reinforcement elements 60. Additionally, reinforcement elements 60 also provide mass for seismic detection element 100. In the case of a realization of seismic detection element 100 as a rocker device, a mass asymmetry of the two rocker arms 20, 21 may be increased in this manner, which advantageously increases a sensitivity of the rocker device. The functional principle of the Z sensor, which is based on developing first rocker arm 20 to be as heavy as possible and to develop second rocker arm 21 to be as light as possible, is advantageously supported in this manner.

Reinforcement elements 60 are advantageously developed running in the y direction in parallel to the axis of torsion spring 10 traversing the entire first rocker arm 20. A cross section of reinforcement elements 60 in the xz plane is developed, as a result of the gas-phase etching process, to be generally rectangular or trapezoid, it being possible for a dimension of reinforcement elements 60 to have typical values of micromechanics in the μm range. In one variant, it is also possible for example to develop reinforcement elements 60 only in a locally restricted manner and partially, e.g., in pointwise fashion, over the area of one or both rocker arms 20, 21.

FIG. 6 shows a flow chart of the principle of a specific embodiment of a method for manufacturing a seismic detection element for a micromechanical sensor.

A third functional layer FP is developed in a first step 200.

In a second step 210, a second functional layer OK is developed in sections on third functional layer FP.

In a step 220, a first functional layer EP is developed on third functional layer FP and second functional layer OK.

The present invention provides a seismic detection element for a micromechanical sensor and a method for manufacturing such a detection element, allowing for an increased robustness and thus improved working properties of the micromechanical sensor. This may be achieved in a technically simple manner by way of a specifically reinforced cavity or multiple cavities in an intermediary functional layer.

Advantageously, it is possible to apply the described principle also to other sensor technologies and sensor topologies, for example to piezoresistive micromechanical accelerations sensors or rate-of-rotation sensors.

Although the present invention has been described with reference to concrete specific embodiments, it is in no way limited to these. One skilled in the art will recognize that diverse modifications are possible, which were not described above or were described only partially, without deviating from the core of the present invention.

What is claimed is:

1. A seismic detection element for a micromechanical sensor, comprising:
a first functional layer, a second functional layer and a third functional layer, the second functional layer being situated between the first functional layer and the third functional layer, the second functional layer having a defined number of cavities;
reinforcement elements situated between the cavities, the reinforcement elements being firmly connected to the first functional layer and to the third functional layer.

2. The seismic detection element as recited in claim 1, wherein the first functional layer has a first perforation and the third functional layer has a second perforation.

3. The seismic detection element as recited in claim 2, wherein diameters of the second perforation are definably smaller than diameters of the first perforation.

4. The seismic detection element as recited in claim 2, wherein diameters of the second perforation are essentially identical to diameters of the first perforation.

5. The seismic detection element as recited in claim 1, wherein the seismic detection element is an asymmetrically designed rocker device of a Z sensor.

6. The seismic detection element as recited in claim 5, wherein the asymmetry, of the rocker device is designed as at least one of a geometric asymmetry and a mass asymmetry, of the rocker device.

7. The seismic detection element as recited in claim 5, wherein the cavities are in at least one of the rocker arms of the rocker device.

8. The seismic detection element as recited in claim 1, wherein the reinforcement elements are connected at least in pointwise fashion to the first and third functional layers.

9. A micromechanical sensor having a seismic detection element, the seismic detection element comprising:
a first functional layer, a second functional layer and a third functional layer, the second functional layer being situated between the first functional layer and the third functional layer, the second functional layer having a defined number of cavities;
reinforcement elements situated between the cavities, the reinforcement elements being firmly connected to the first functional layer and to the third functional layer.

10. A method for manufacturing a seismic detection element for a micromechanical sensor, comprising:
forming a third functional layer;
forming by sections a second functional layer on the third functional layer; and
forming a first functional layer on the third functional layer and the second functional layer.
